(19) United States
(12) Patent Application Publication
(10) Pub. No.: US 2022/0080698 A1
(43) Pub. Date: Mar. 17, 2022

(54) INSULATED BUILDING STUDS AND METHODS OF MANUFACTURE

(71) Applicant: Christopher J. LAING, Gansevoort, NY (US)

(72) Inventor: Christopher J. LAING, Gansevoort, NY (US)

(21) Appl. No.: 17/447,359

(22) Filed: Sep. 10, 2021

Related U.S. Application Data
(60) Provisional application No. 62/706,802, filed on Sep. 11, 2020.

(51) Int. Cl. B32B 3/18; E04B 1/78; E04C 3/36; B32B 5/02; B32B 5/18; B32B 5/24; B32B 7/12; B32B 21/10; B32B 37/12; B32B 37/10; B32B 37/18

(52) U.S. Cl. CPC B32B 3/18; B32B 2315/085; E04C 3/36; B32B 5/028; B32B 5/18; B32B 5/245; B32B 7/12; B32B 21/10; B32B 37/12; B32B 37/10; B32B 37/182; B32B 2307/304; B32B 2419/00; B32B 2250/40; B32B 2266/0228; B32B 2305/022; B32B 2317/16; B32B 2262/101; E04B 1/78

(57) ABSTRACT

Insulated building studs and methods of manufacturing the insulated building studs are disclosed. The insulated building studs includes a first portion, a second portion, an insulated portion with a first side and a second side, wherein the first portion is coupled to the first side of the insulated portion and the second portion is coupled to the second side of the insulated portion to form a building member, and at least one mesh coupled to at least one of a top and a bottom of the building member. A method of manufacturing insulated building studs is also disclosed.

### CROSS REFERENCE TO RELATED APPLICATION

This application claims priority benefit under 35 U.S.C. § 119(e) of U.S. provisional application No. 62/706,802 filed Sep. 11, 2020, entitled Insulated Building Studs and Methods of Manufacture, which is incorporated herein by reference in its entirety.

### FIELD OF THE INVENTION

The present invention relates generally to insulated building studs. More specifically, but not exclusively, the present invention concerns insulated building studs and methods of manufacture of the insulated building studs.

### BACKGROUND OF THE INVENTION

Currently, building studs used in construction create a thermal bypass, especially in exterior wall sections. A thermal bypass is an area where a portion or component of an item has higher thermal conductivity than the surrounding materials. The areas of higher thermal conductivity create a path of least resistance for heat transfer. Thus, heat and cold are able to pass across the building studs and decrease a buildings overall temperature efficiency. Conduction of heat through the building studs from the warmer side of the wall to the cooler side of the wall results in energy loss and more costly energy bills. Therefore, in order to avoid energy loss due to thermal bypass, insulated building studs which form a thermal break and methods for making those insulated building studs are needed.

### SUMMARY OF THE INVENTION

Aspects of the present invention provide insulated building studs and methods of manufacturing the same.

In one aspect, provided herein is an insulated building stud, including a first portion, a second portion, an insulated portion with a first side and a second side, wherein the first portion is coupled to the first side of the insulated portion and the second portion is coupled to the second side of the insulated portion to form a building member, and at least one mesh coupled to at least one of a top and a bottom of the building member.

In another aspect, provided herein is a method of manufacturing an insulated building stud, including obtaining a first portion, obtaining a second portion, and obtaining an insulated portion. The method also includes coupling the first portion to a first side of the insulated portion and coupling the second portion to a second side of the insulated portion. The method further includes securing at least one mesh to the coupled first portion, second portion, and insulated portion.

These, and other objects, features and advantages of this invention will become apparent from the following detailed description of the various aspects of the invention taken in conjunction with the accompanying drawings.

### BRIEF DESCRIPTION OF DRAWINGS

The accompanying drawings, which are incorporated in and constitute a part of the specification, illustrate embodiments of the invention and together with the detailed description herein, serve to explain the principles of the invention. The drawings are only for purposes of illustrating preferred embodiments and are not to be construed as limiting the invention. It is emphasized that, in accordance with the standard practice in the industry, various features are not drawn to scale. In fact, the dimensions of the various features may be arbitrarily increased or reduced for clarity of discussion. The foregoing and other objects, features and advantages of the invention are apparent from the following detailed description taken in conjunction with the accompanying drawings in which:

FIG. 1 is an end view of an insulated building stud, in accordance with an aspect of the present disclosure;

FIG. 2 is a side view of the insulated building stud of FIG. 1, in accordance with an aspect of the present disclosure;

FIG. 3 is a side perspective view of a portion of the insulated building stud of FIG. 1, in accordance with an aspect of the present disclosure;

FIG. 4 is a side perspective view of the insulated building stud of FIG. 1, in accordance with an aspect of the present disclosure;

FIG. 5 is an exploded, end view of the insulated building stud of FIG. 1, in accordance with an aspect of the present disclosure;

FIG. 6 is an exploded, end perspective view of a portion 102 of the insulated building stud of FIG. 1 as shown in FIG. 4, in accordance with an aspect of the present disclosure; and

FIG. 7 depicts the method of manufacturing insulated building studs, in accordance with an aspect of the present disclosure.

### DETAILED DESCRIPTION FOR CARRYING OUT THE INVENTION

Generally stated, disclosed herein are embodiments of insulated building studs. Further, methods for manufacturing the insulated building studs are also disclosed.

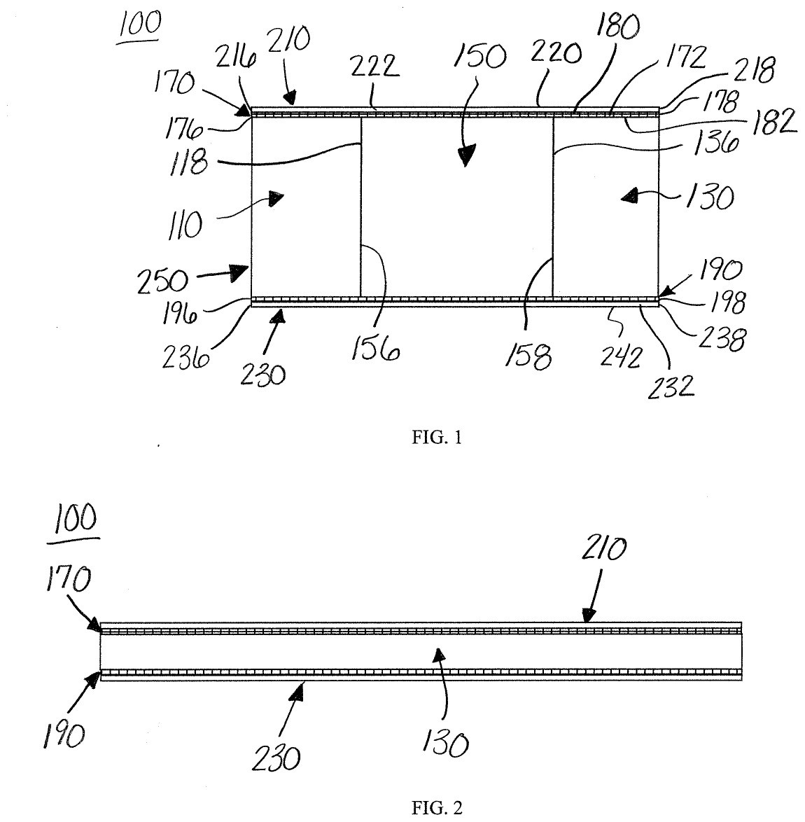

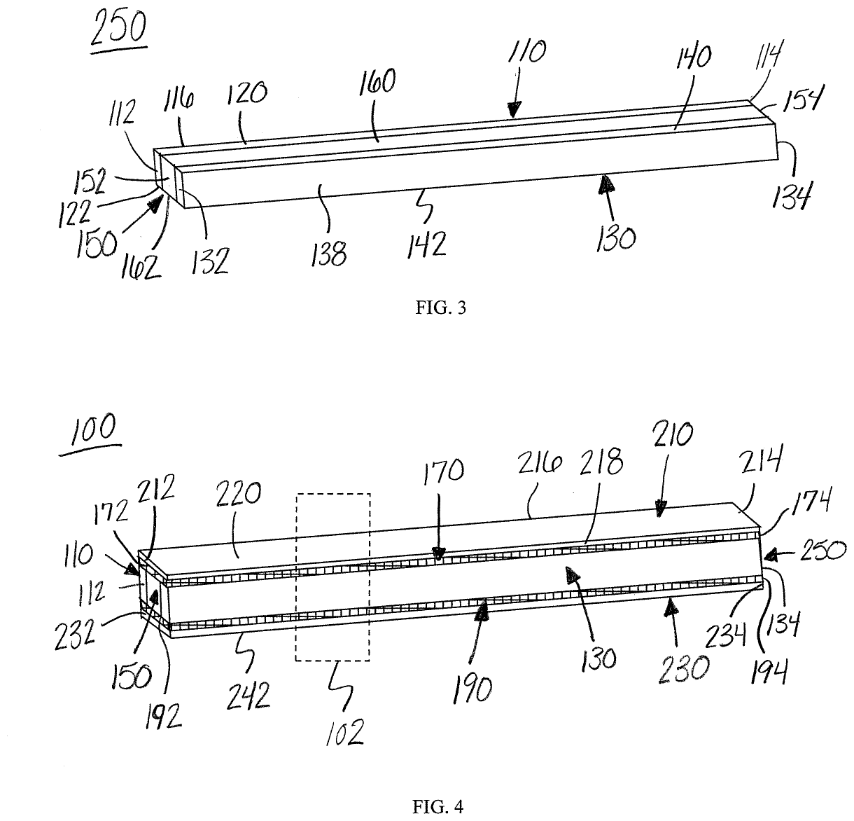

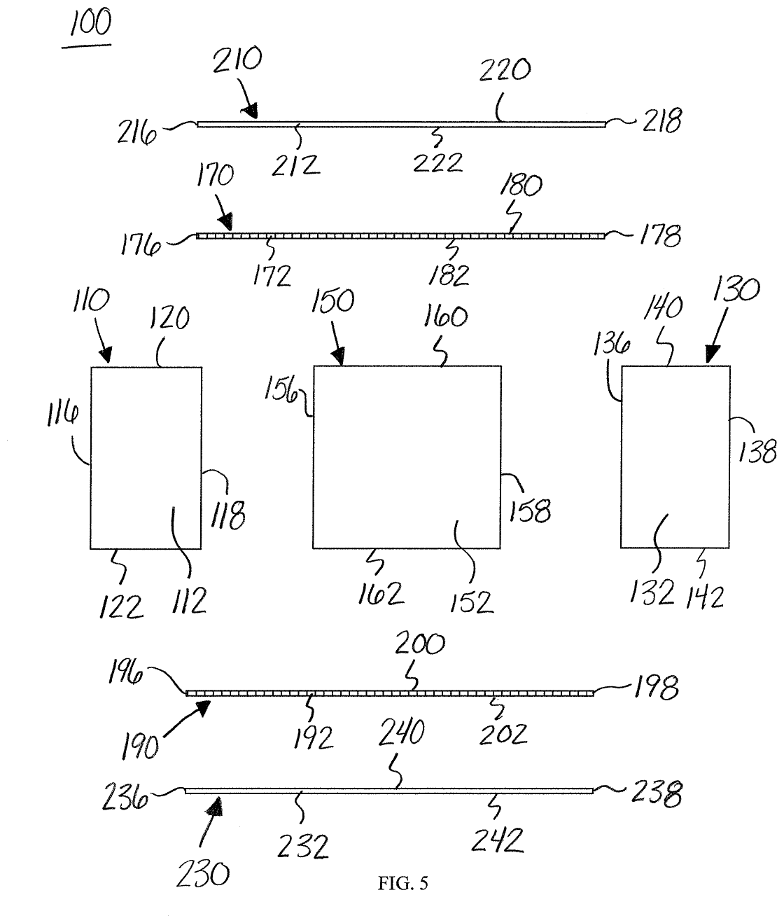

Referring to the drawings, wherein like reference numerals are used to indicate like or analogous components throughout the several views, and with particular reference to FIGS. 1-6, there is illustrated an exemplary embodiment of an insulated building stud 100. The building stud 100 includes a first portion 110, a second portion 130, an insulated portion 150, and at least one first mesh layer 170 coupled (directly or indirectly) to the first portion 110, the second portion 130, and the insulated portion 150. The building stud 100 may also include at least one second mesh layer 190 coupled (directly or indirectly) to the first portion 110, the second portion 130, and the insulated portion 150. The at least one first mesh layer 170 may be coupled to a side opposite the at least one second mesh 190. The building stud 100 may further include at least one first cover portion 210 and at least one second cover portion 230. The at least one first cover portion 210 may be coupled to the at least one first mesh layer 170. The at least one second cover portion 230 may be coupled to the at least one second mesh layer 190.

In some embodiments, the first portion 110 may be formed of wood (i.e., a first wood portion). The wood used to form the first portion 110 may be, for example, a spruce-pine-fir (SPF) mix wood or the like used in building and/or construction. In some other embodiments, the first portion 110 may be formed of, for example, a metal, a plastic, or a composite material. The first portion 110 may be a singular integral or monolithic piece (i.e., of one-piece construction), or may be formed from a plurality of components that are coupled (e.g., rigidly coupled) together to form the first portion 110. In some embodiments, the second portion 130 may be formed of, for example, a wood (i.e., a second wood portion). The wood used to form the second portion 130 may be, for example, a spruce-pine-fir (SPF) mix wood or the like used in building and/or construction. In some other embodiments, the second portion 130 may be formed of, for example, a metal, a plastic, or a composite material. The second portion 130 may be a singular integral or monolithic piece (i.e., of one-piece construction), or may be formed from a plurality of components that are coupled (e.g., rigidly coupled) together to form the second portion 130.

The size and shape of the building studs 100 may correspond to standard dimensional lumber and/or construction sizes and shapes, such as being, for example, 2″×6″, 2″×8″, or larger. The building studs 100 may also come in various lengths (e.g., standard dimensional lumber and/or construction lengths), for example, 8 feet, 9 feet, 10 feet, 12 feet and the like known lengths for studs. For example, a 2″×6″ building stud 100 may include a 2″×3″ first portion 110, a 2″×3″ second portion 130, and a 2.5″×2.5″ insulated portion 150. As known by one of ordinary skill in the art, a dimensional 2″×3″ board actually measures approximately 1.5″ by 2.5″, and a dimensional 2″×6″ stud actually measures approximately 1.5″ by 5.5″. However, it is also contemplated that the building stud 100 may have alternative dimensions with differing or like ratios between the first portion 110, the second portion 130, and the insulated portion 150, as would be understood by one of ordinary skill in the art. As also known by one of ordinary skill in the art, the dimensions of a 2.5″×2.5″ insulated portion 150 are actually 2.5″×2.5″ and the length is selected based on the length needed for the project and may be, for example, any standard dimensional lumber and/or construction length.

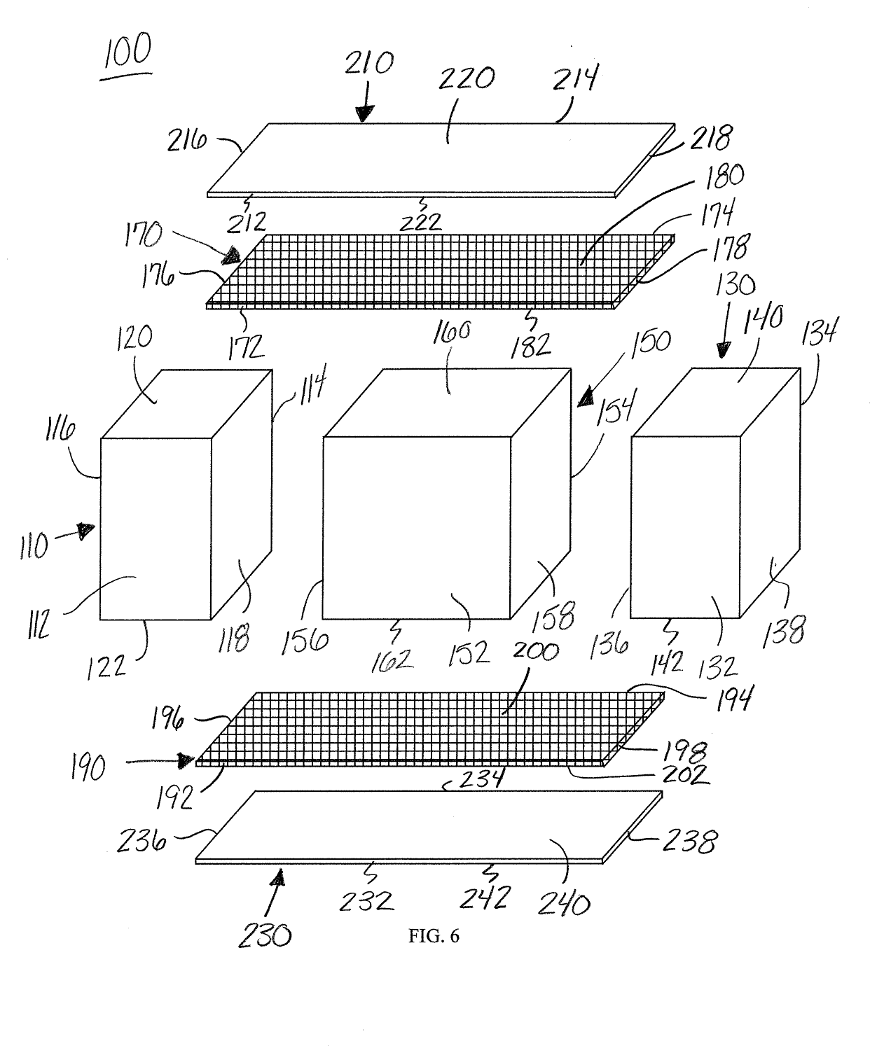

As shown in FIG. 6, the first portion 110 includes a first end 112, a second end 114 opposite the first end 112, a first side 116, a second side 118 opposite the first side 116, a top 120, and a bottom 122 opposite the top 120. The second portion 130 includes a first end 132, a second end 134 opposite the first end 132, a first side 136, a second side 138 opposite the first side 136, a top 140, and a bottom 142 opposite the top 140. The insulated portion 150 includes a first end 152, a second end 154 opposite the first end 152, a first side 156, a second side 158 opposite the first side 156, a top 160, and a bottom 162 opposite the top 160. The insulated portion 150 may be, for example, a rigid insulation material, such as, rigid foam board (open or closed cell), and the like. In some embodiments, the rigid foam board may be, for example, polystyrene. The insulated portion 150 may be, for example, continuous between the first portion 110 and the second portion 130. The continuous insulated portion 150 may be, for example, uninterrupted and absent of voids. The insulated portion 150 may also be, for example, a non-extruded foam. In other embodiments, the insulated portion 150 may be, for example, an injected or extruded foam (closed cell) formed into a 2.5″×2.5″ insulated portion 150 at any desired length.

As shown in FIGS. 1-4, the second side 118 of the first portion 110 may be coupled to the first side 156 of the insulated portion 150. The first portion 110 and the insulated portion 150 may be directly or indirectly coupled together. In some embodiments, the first portion 110 and the insulated portion 150 may be in direct contact or abutment. In some other embodiments, the first portion 110 and the insulated portion 150 may be indirectly coupled via an intermediate member or material therebetween. In some embodiments, the second side 118 may be coupled to the first side 156 by an adhesive, for example, glue, construction adhesive, industrial structural insulated panels (SIPs) adhesive, such as, polychloroprene adhesive, urethane adhesive (polyurethane adhesive), methacrylate adhesive, and the like. The adhesive should be of the type that does not degrade or destroy the insulated portion 150, i.e., the foam.

The first side 136 of the second portion 130 may be coupled to the second side 158 of the insulated portion 150. The second portion 130 and the insulated portion 150 may be directly or indirectly coupled together. In some embodiments, the second portion 130 and the insulated portion 150 may be in direct contact or abutment. In some other embodiments, the second portion 130 and the insulated portion 150 may be indirectly coupled via an intermediate member or material therebetween. In some embodiments, the first side 136 may be coupled to the second side 158 by an adhesive, for example, glue, construction adhesive, industrial SIPs adhesive, such as, polychloroprene adhesive, urethane adhesive (polyurethane adhesive), methacrylate adhesive, and the like. The coupled first portion 110, second portion 130, and insulated portion 150 form a building member 250 (which may be a standard dimensional lumber size), for example, a 2″×6″, 2″×8″ or larger.

With continued reference to FIG. 6, the at least one first mesh layer 170 may include a first end 172, a second end 174 opposite the first end 172, a first side 176, a second side 178 opposite the first side 176, a top 180, and a bottom 182 opposite the top 180. In addition, the at least one second mesh layer 190 may include a first end 192, a second end 194 opposite the first end 192, a first side 196, a second side 198 opposite the first side 196, a top 200, and a bottom 202 opposite the top 200. The at least one first mesh layer 170 and/or the at least one second mesh layer 190 may be a singular integral or monolithic piece (i.e., of one-piece construction), or may be formed from a plurality of components that are coupled together to form the respective mesh layer 170, 190. The at least one first mesh layer 170 and the at least one second mesh layer 190 may be, for example, fiberglass mesh, or a like material as known by one of ordinary skill in the art.

The at least one first mesh layer 170 and/or the at least one second mesh layer 190 may comprise or form through holes, openings or apertures that extend therethrough. For example, the at least one first mesh layer 170 may comprise a plurality of openings that extend from the top side 180 to the bottom side 182. Similarly, the at least one second mesh layer 190 may comprise a plurality of openings that extend from the top side 200 to the bottom side 202. In some other embodiments, the at least one first mesh layer 170 and/or the at least one second mesh layer 190 may be substantially solid (i.e., void of the above-discussed openings).

The at least one first cover 210 portion may include a first end 212, a second end 214 opposite the first end 212, a first side 216, a second side 218 opposite the first side 216, a top 220, and a bottom 222 opposite the top 220. The at least one second cover 230 may include a first end 232, a second end 234 opposite the first end 232, a first side 236, a second side 238 opposite the first side 236, a top 240, and a bottom 242 opposite the top 240. The at least one first cover 210 and the at least one second cover 230 may be, for example, house wrap, building paper, or a like material as known by one of ordinary skill in the art.

The at least one first mesh layer 170, the at least one second mesh layer 190, the at least one first cover 210 and/or the at least one second cover 230 may be substantially flexible (e.g., manually flexible), while the first portion 110, the second portion 130 and/or the insulated portion 150 may be substantially rigid or stiff.

The at least one first mesh layer 170 may be coupled (directly or indirectly) to the top surface 120, 140, 160 of the building member 250, as shown in FIGS. 1, 2 and 4. The at least one first mesh layer 170 may be coupled (directly or indirectly) to the building member 250 using an adhesive, for example, glue, construction adhesive, industrial SIPs adhesive, such as, polychloroprene adhesive, urethane adhesive (polyurethane adhesive), methacrylate adhesive, and the like. In some embodiments, the at least one first mesh layer 170 and the top surface 120, 140, 160 of the building member 250 may be in direct contact or abutment. In some other embodiments, the at least one first mesh layer 170 and the top surface 120, 140, 160 of the building member 250 may be indirectly coupled via an intermediate member or material therebetween. In some embodiments, the at least one first mesh layer 170 may be, for example, one, two, three or more first mesh layers 170. When more than one first mesh layer 170 is used the first mesh layers 170 may be, for example, positioned layered on top of each other or alternatively, the first mesh layers 170 may be positioned adjacent to each other or slightly overlapping the adjacent pieces of mesh along the length and/or width of the building member 250. The length of the building member 250 may extend, for example, between the first end 112, 132, 152 and the second end 114, 134, 154 and the width of the building member 250 may extend, for example, between the first side 116 of the first portion 110 to the second side 138 of the second portion 130.

At least one first cover portion 210 may be applied over the at least one first mesh layer 170 and coupled to the top surface 180 of the at least one first mesh layer 170. The at least one first cover portion 210 may be coupled (directly or indirectly) by the adhesive or other material and/or coupling mechanism that couples the at least one first mesh layer 170 to the building member 250. In some other embodiments the at least one first cover portion 210 may be coupled to the at least one first mesh layer 170 and/or to the building member 250 by an additional material or mechanism. In some embodiments, the at least one first cover portion 210 and the at least one first mesh layer 170 may be in direct contact or abutment. In some other embodiments, the at least one first cover portion 210 and the at least one first mesh layer 170 may be indirectly coupled via an intermediate member or material therebetween. In some embodiments, the at least one first cover portion 210 may be, for example, one, two, or more cover portions 210. When more than one first cover portion 210 is used, the first cover portion 210 may be, for example, positioned layered on top of each other or alternatively, the first cover portions 210 may be positioned adjacent to each other or slightly overlapping the adjacent cover portion 210 along the length and/or width of the building member 250.

The at least one second mesh layer 190 may be coupled (directly or indirectly) to the bottom surface 122, 142, 162 of the building member 250, as shown in FIGS. 1, 2 and 4. The at least one second mesh layer 190 may be coupled (directly or indirectly) to the building member 250 using an adhesive, for example, glue, construction adhesive, industrial SIPs adhesive, such as, polychloroprene adhesive, urethane adhesive (polyurethane adhesive), methacrylate adhesive, and the like. In some embodiments, the at least one second mesh layer 190 and the bottom surface 122, 142, 162 of the building member 250 may be in direct contact or abutment. In some other embodiments, the at least one second mesh layer 190 and the bottom surface 122, 142, 162 of the building member 250 may be indirectly coupled via an intermediate member or material therebetween. In some embodiments, the at least one second mesh layer 190 may be, for example, one, two, three or more second mesh layers 190. When more than one second mesh layer 190 is used the second mesh layers 190 may be, for example, positioned layered on top of each other or alternatively, the second mesh layers 190 may be positioned adjacent to each other or at least slightly overlapping the adjacent layers along the length and/or width of the building member 250.

At least one second cover portion 230 may be applied over the at least one second mesh layer 190 and coupled to the bottom surface 202 of the at least one second mesh layer 190. The at least one second cover portion 230 may be coupled (directly or indirectly) by the adhesive or other material and/or coupling mechanism that couples the at least one second mesh layer 190 to the building member 250. In some other embodiments, the at least one second cover portion 230 may be coupled to the at least one second mesh layer 190 and/or to the building member 250 by an additional material or mechanism. In some embodiments, the at least one second cover portion 230 and the at least one second mesh layer 190 may be in direct contact or abutment. In some other embodiments, the at least one second cover portion 230 and the at least one second mesh layer 190 may be indirectly coupled via an intermediate member or material therebetween. In some embodiments, the at least one second cover portion 230 may be, for example, one, two, or more cover portions 230. When more than one second cover portion 230 is used the second cover portion 230 may be, for example, positioned layered on top of each other or alternatively, the second cover portions 230 may be positioned adjacent to each other or slightly overlapping the adjacent cover portion 230 along the length and/or width of the building member 250.

In an alternative embodiment, it is also contemplated that the mesh layers 170, 190 may entirely surround the building member 250 along the length of the building member 250. In this alternative embodiment the cover portions 210, 230 may also entirely surround the building member 250 along the length. In yet a further alternative embodiment, it is contemplated that the mesh layers 170, 190 may be positioned on the top 120, 140, 160 and bottom 122, 142, 162 of the building member 250 and the cover portions 210, 230 may entirely surround the building member 250.

The insulated building studs 300 may provide, for example, less warping and a more consistent strength than prior studs, such as current typical wooden studs. In addition, the insulated building studs 300 may be less costly than prior insulated studs because they utilize fewer materials and less steps are needed to manufacture the insulated building studs 300. The insulated building studs 300 may also reduce vibration, thermal and/or sound transmission therethrough than compared to prior studs. For example, wall, floor and/or ceiling structures formed via the insulated building studs 300 may provide enhanced vibration and/or noise damping, and thermal insulative quality, than as compared to such structures formed with current studs.

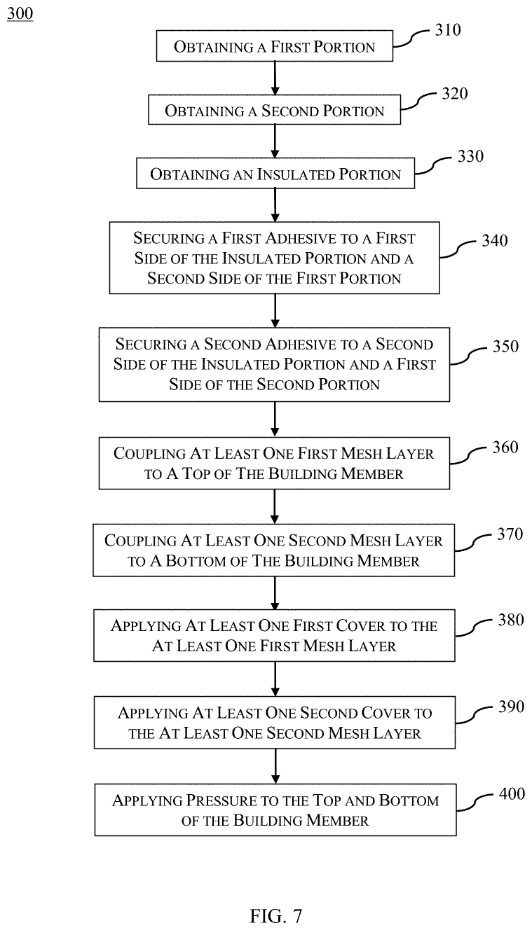

The method of manufacturing the insulated building studs 300 is shown in FIG. 7. The method may include obtaining a first portion 310, obtaining a second portion 320, and obtaining an insulated portion 330. The first portion and the second portion may be, for example, a first wood portion and a second wood portion, respectively. Next, an adhesive (and/or another material or mechanism) may be used to secure a first side of the insulated portion to a second side of the first portion 340. An adhesive (and/or another material or mechanism) may also be used to secure a second side of the insulated portion to a first side of the second portion forming a building member 350. Then, an adhesive (and/or another material or mechanism) may be used to couple the at least one first mesh layer to a top of the building member 360. The method may also include applying the at least one second mesh layer to a bottom of the building member using an adhesive (and/or another material or mechanism) 370. Optionally, at least one first cover portion may be applied over the at least one first mesh layer and adhesive 380 and at least one second cover portion may be applied over the at least one second mesh layer and adhesive (and/or another material or mechanism) 390. Finally, pressure may be applied to the top and bottom over the mesh layers or cover portions to form the insulated building stud 400.

The method may also include forming the building member 250 using sheets of the first and second portions 110, 130, for example, sheets of wood, and a sheet of the insulated portion 150. Once the sheets are coupled together, the individual building members 250 may be cut to size. Then, the mesh layers 170, 190 and cover portions 210, 230 may be applied as discussed in greater detail above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The invention has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the invention be construed as including all such modifications and alterations.

Having thus described the preferred embodiments, the invention is now claimed to be:

1. An insulated building stud, comprising:
a first portion;
a second portion;
an insulated portion with a first side and a second side, wherein the first portion is coupled to the first side of the insulated portion and the second portion is coupled to the second side of the insulated portion to form a building member; and
at least one mesh coupled to at least one of a top and a bottom of the building member.

2. The insulated building stud of claim 1, wherein the at least one mesh comprises:
at least one first mesh layer coupled to the top of the building member.

3. The insulated building stud of claim 2, wherein the at least one mesh further comprises:
at least one second mesh layer coupled to the bottom of the building member.

4. The insulated building stud of claim 3, wherein the at least one first mesh layer is coupled to the top of the building member with a first adhesive.

5. The insulated building stud of claim 4, wherein the at least one second mesh layer is coupled to the bottom of the building member with a second adhesive.

6. The insulated building stud of claim 5, wherein the first adhesive and the second adhesive are the same.

7. The insulated building stud of claim 3, further comprising:
at least one first cover portion coupled to the at least one first mesh layer.

8. The insulated building stud of claim 7, wherein a first adhesive couples the at least one first mesh layer to the top of the building member and the at least one first cover portion to the at least one first mesh layer.

9. The insulated building stud of claim 7, further comprising:
at least one second cover portion coupled to the at least one second mesh layer.

10. The insulated building stud of claim 9, wherein a second adhesive couples the at least one second mesh layer to the bottom of the building member and the at least one second cover portion to the at least one second mesh layer.

11. The insulated building stud of claim 1, wherein the insulated portion is continuous between the first portion and the second portion.

12. The insulated building stud of claim 1, wherein the first portion is wood and wherein the second portion is wood.

13. A method of manufacturing an insulated building stud, comprising:
obtaining a first portion;
obtaining a second portion;
obtaining an insulated portion;
coupling the first portion to a first side of the insulated portion;
coupling the second portion to a second side of the insulated portion; and
securing at least one mesh to the coupled first portion, second portion, and insulated portion.

14. The method of claim 13, wherein the first portion is coupled to the insulated portion by a first adhesive, wherein the second portion is coupled to the insulated portion by a second adhesive, and wherein the coupled first portion, second portion, and insulated portion form a building member.

15. The method of claim 14, wherein the at least one mesh is secured to the building member by a third adhesive.

16. The method of claim 15, wherein securing at least one mesh comprises:
securing at least one first mesh layer to a top of the building member; and
securing at least one second mesh layer to a bottom of the building member.

17. The method of claim 16, further comprising:
applying at least one first cover portion over the at least one first mesh portion.

18. The method of claim 17, further comprising:
applying at least one second cover portion over the at least one second mesh portion.

19. The method of claim 18, further comprising:
applying pressure to the top and the bottom of the building member.

20. The method of claim 13, wherein the first portion is wood and where the second portion is wood.
